(19) United States
(12) Patent Application Publication
(10) Pub. No.: US 2019/0391348 A1
(43) Pub. Date: Dec. 26, 2019

(54) HETEROGENEOUS COMMON SUBSTRATE MULTI-CHIP PACKAGE INCLUDING PHOTONIC INTEGRATED CIRCUIT AND DIGITAL SIGNAL PROCESSOR

(71) Applicant: Infinera Corporation, Sunnyvale, CA (US)

(72) Inventors: John Osenbach, Kutztown, PA (US); Jiaming Zhang, Macunge, PA (US); Xiaofeng Han, Allentown, PA (US); Timothy Butrie, Hellertown, PA (US); Fred Kish, JR., Palo Alto, CA (US)

(73) Assignee: Infinera Corporation, Palo Alto, CA (US)

(21) Appl. No.: 16/279,874

(22) Filed: Feb. 19, 2019

Related U.S. Application Data
(60) Provisional application No. 62/632,338, filed on Feb. 19, 2018.

(51) Int. Cl. G02B 6/42; H04B 10/40

(52) U.S. Cl. CPC G02B 6/4257; G02B 6/4267; G02B 6/4269; H04B 10/40; G02B 6/4245; G02B 6/4251; G02B 6/4238

(57) ABSTRACT

An optical transceiver package comprising a transceiver module, a digital signal processor (DSP), a substrate supporting the transceiver module and the DSP, and a barrier to mechanically protect and thermally insulate the transceiver module. The substrate comprises a material having a coefficient of thermal expansion (CTE) of 2.3-14 ppm/° C. and the barrier comprises a material having a CTE of 3.5-14 ppm/° C.

### CROSS-REFERENCE TO RELATED APPLICATION

This application claims the benefit of U.S. Provisional Patent Application Ser. No. 62/632,338, filed on Feb. 19, 2018, entitled Heterogeneous Common Substrate Multi-Chip Package Including a Photonic Integrated Circuit and a Digital Signal Processor, the contents of which are incorporated by reference.

### BACKGROUND

The present disclosure is directed toward compact packages housing multiple chips mounted or bonded to a common substrate. Such chips may include different materials, such as indium phosphide (InP), gallium arsenide (GaAs) or other Group III-V materials, as well as silicon (Si) or silicon-based materials, such as silicon-germanium (SiGe). The chips may include both optical and electrical devices, such as InP electronics, GaAs electronics, and Si-complementary metal-oxide-semiconductor circuits (Si-CMOS).

Photonic integrated circuits (PICs) may include multiple optical devices provided on a common substrate. Such substrate may include, for example, InP, gallium arsenide (GaAs), or other Group III-V materials. The optical devices of a PIC may include lasers, optical modulators, such as Mach-Zehnder modulators, semiconductor optical amplifiers (SOAs), optical hybrids, and photodiodes. Lasers and modulators are often provided in a transmitter (Tx) PIC, and local oscillator lasers, optical hybrids, and photodiodes may be provided in a receiver (Rx) PIC. Alternatively, both transmit and receive devices may be provided on the same substrate in a transceiver (XCVR) PIC.

In coherent optical systems including PICs, client data may be received by a transmit node in a network, processed, and provided to a digital signal processor (DSP) in the transmit node. The DSP, in turn, may encode the data in accordance with a Forward Error Correction (FEC) code, as well as convert the processed data into a series of symbols, each of which representing a corresponding bit grouping. The DSP carries out additional processing of the received data after being processed by the optical receiver and analog electronics.

The DSP may output the symbols or other processed data to a circuit, such as an application specific integrated circuit (ASIC), which, in turn, generates appropriate analog drive signals that may be provided to modulators in a Tx PIC. At a receive node, the optical signals are detected by mixing such signals with light output from a local oscillator laser and supplying the resulting mixing products to one or more photodiodes. The photodiodes, in turn, supply corresponding electrical signals to circuitry, such as a transimpedance amplifier or other high-speed electronic amplifier circuits, which may be included in a second ASIC provided in the receive node. The second ASIC may further process the electrical signals and supply such processed electrical signals to an analog-to-digital converter (ADC). Based on the received electrical signals, the ADC supplies corresponding digital data to a DSP, which may also be provided in the receive node. The DSP may perform carrier recovery and FEC decoding to generate data, which may be further processed and output to the client.

Higher data and symbol rates may require modulation formats, such as 16 quadrature amplitude modulation (QAM) formats or higher order formats. At high frequencies or RF frequencies associated with these modulation formats and symbol/data rates, electrical signals provided from the DSP to the transmit ASIC, including, for example, modulator driver circuitry, and from the transmit ASIC to the Tx PIC, as well as electrical signals output from the Rx PIC to the receive ASIC, including, for example, a transimpedance amplifier, and from the receive ASIC to the DSP incur loss due to impedance mismatch between various conductors carrying these electrical signals. That is, the impedance mismatch causes reflections, which can dissipate the energy of the electrical signals. Additional losses may be incurred via absorption and leakage in dielectrics and metals, etc.

As generally understood, the transmitted symbols carried by 16 QAM modulated signals, for example, correspond to constellation points on an in-phase (I) and quadrature (Q) plane and such points may be located at different distances or amplitudes from the origin of the IQ plane. Impedance mismatch and other losses may cause the amplitude associated with a particular constellation point, for example, to be reduced, whereby the location of that point may shift and the symbol corresponding to that point may not be accurately detected. As a result, losses in between the PIC, ASIC and DSP, in both the transmit and receive nodes, can create errors in data transmission.

Losses may also be incurred over longer transmission distances between the PICs, ASICs, and DSPs. Such losses increase at higher frequencies and modulation rates. Since the energy of a particular wavelength is split across all I and Q symbols, higher modulation rates are more susceptible to losses than lower modulation rates.

In a conventional optical communication system, line cards may be provided with high-speed optical transmitter and receiver modules in separate packages, as well as separately packaged DSPs. At data rates having associated frequencies of about 20-25 GHz, RF cables may be provided to minimize the RF losses noted above. However, such cables may be relatively expensive and, due to their size or form factor, may be difficult to incorporate into a compact package. In addition, the volume, stability, and shape, for example, of the solder connection to the cable can degrade RF performance. Moreover, since the solder connection has a small size, consistent and reliable RF performance may be difficult to achieve in high volume, manufacturable quantities. Further, the relatively large size of a link, including such RF cables, may also degrade RF performance.

### SUMMARY

Consistent with an aspect of the present disclosure, an optical transceiver package is provided comprising a transceiver module, a DSP, a substrate supporting the transceiver module and the DSP, and a barrier to mechanically protect and thermally insulate the transceiver module, wherein the substrate comprises a material having a coefficient of thermal expansion (CTE) of 2.3-14 ppm/° C. and the barrier comprises a material having a CTE of 3.5-14 ppm/° C.

Consistent with another aspect of the present disclosure, an optical transceiver package is provided comprising, a transmitter PIC, a receiver PIC, a DSP, a substrate supporting the transceiver module and the DSP, and a barrier to mechanically protect and thermally insulate the transmitter PIC and the receiver PIC, wherein the substrate comprises a material having a CTE of 2.3-14 ppm/° C. and the barrier comprises a material having a CTE of 3.5-14 ppm/° C.

Consistent with yet another aspect of the present disclosure, an optical transceiver package is provided comprising a transmitter module including a transmitter PIC, a receiver module including a receiver PIC, a first DSP, a second DSP, a substrate supporting the transmitter module, the receiver module, the first DSP, and the second DSP, a first barrier to mechanically protect and thermally insulate the transmitter module, and a second barrier to mechanically protect and thermally insulate the receiver module, wherein the substrate comprises a material having a CTE of 2.3-14 ppm/° C., the first barrier comprises a material having a CTE of 3.5-14 ppm/° C., and the second barrier comprises a material having a CTE of 3.5-14 ppm/° C.

It is to be understood that both the foregoing general description and the following detailed description are exemplary and explanatory only and are not restrictive of the invention, as claimed.

The accompanying drawings, which are incorporated in and constitute a part of this specification, illustrate several embodiments and together with the description, serve to explain the principles of the invention.

### BRIEF DESCRIPTION OF THE DRAWINGS

FIG. 1 illustrates a chassis for housing circuit components and other related equipment consistent with the present disclosure.

FIG. 2 illustrates a simplified plan view of a transceiver package consistent with an aspect of the present disclosure.

FIG. 3 illustrates a transceiver package consistent with another aspect of the present disclosure.

FIGS. 4, 5A, and 5B illustrate perspective, plan, and cross sectional views, respectively, of the package of FIG. 3.

FIG. 6 illustrates simplified cross-sectional view of the package of FIG. 4.

FIGS. 7A and 7B illustrate exemplary configurations of an interposer consistent with the present disclosure.

FIG. 8 illustrates another exemplary package consistent with the present disclosure.

FIG. 9 illustrates a plan or top view of the package of FIG. 8

FIG. 10 illustrates another exemplary package consistent with the present disclosure.

FIG. 11 illustrates a plan view of the package of FIG. 10.

FIG. 12 illustrates another exemplary package consistent with the present disclosure.

FIGS. 13 and 14 are plan and perspective views, respectively, of an exemplary FSO consistent with the present disclosure.

FIG. 15 shows an example of a tunable optical filter consistent with the present disclosure.

FIG. 16 shows another example of a package consistent with the present disclosure.

### DESCRIPTION OF THE EMBODIMENTS

Consistent with the present disclosure, a package is provided that houses a PIC assembly (including a PIC alone or in combination with an ASIC) and a DSP. High speed electrical interconnections are also provided between each of these devices. The package disclosed herein is compact in size so that the PIC assembly, either Tx, Rx, or XCVR, and DSP are connected over relatively short distances. In addition, conductive traces surrounded by a desired dielectric thickness and having appropriate dimensions are provided to control the impedance to match that of the PIC assembly and DSP in order to minimize RF reflectance and therefore reduce loss. Losses attributable to absorption and leakage are also reduced.

In addition, since the PIC assembly and DSP are provided on a common substrate, the number of interfaces along the connections between these devices are reduced compared to a conventional package. Thus, fewer reflections are experienced by the electrical signal as it travels from the DSP to the PIC assembly.

Further, although a compact package is desirable to minimize loss, heat generated by the PIC, ASIC, and DSP may degrade performance of these devices. Accordingly, consistent with a further aspect of the present disclosure, thermal management techniques may be employed to transfer or dissipate heat generated by the PIC, ASIC, and DSP. In one example, the package disclosed herein may dissipate between 50 to 300 W of heat generated by the DSP. In a further example, up to 200 W of heat generated by the DSP may be dissipated. In addition, preferably heat generated by the Tx PIC and/or ASIC (and dissipated by the disclosed package) may be in a range of 5-75 W, but may typically be less than 45 W. Further, heat generated by the Rx PIC and ASIC (and dissipated by the disclosed package) may be in a range of 5-50 W, but is often less than 25 W.

Reference will now be made in detail to exemplary embodiments of the present disclosure, examples of which are illustrated in the accompanying drawings. Wherever possible, the same reference numbers will be used throughout the drawings to refer to the same or like parts.

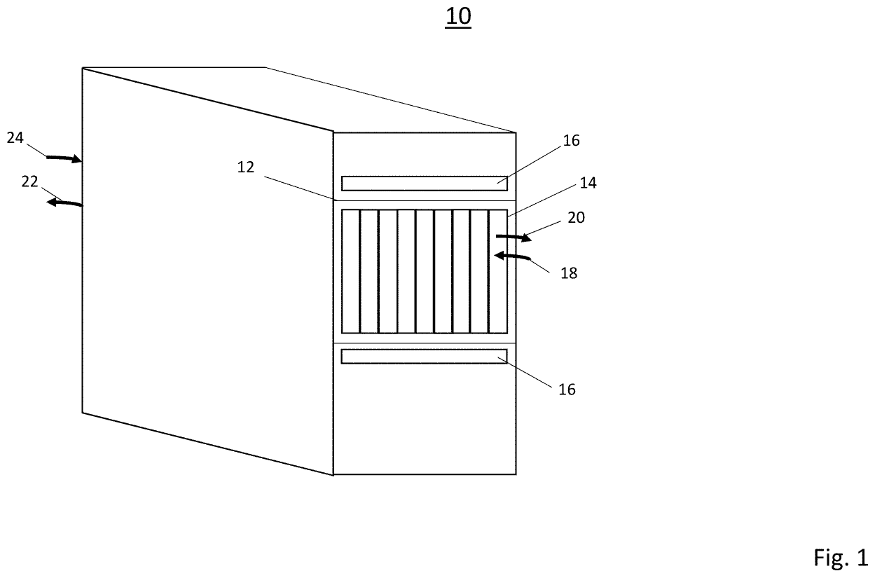

Consistent with the present disclosure, FIG. 1 illustrates a chassis 10 for housing circuit components and other related equipment. The chassis 10 may include, for example, one or more shelves 12, each of which may hold one or more line cards 14. One or more vents 16 and/or fans (not shown) may be provided to draw air into the chassis 10 to cool components on the line cards 14. Each line card 14 may connect to fiber pairs 18 and 20. Fiber 18 supplies optical signals from a client's equipment (not shown) to the line card 14 and fiber 20 supplies optical signals from the line card 14 to the client's equipment. Each line card 14 may also have a “line side” connecting to another fiber pair 22 and 24. Fiber 22 supplies optical signals from the line card 14 to another chassis or node and fiber 24 supplies optical signals from that other chassis or node to the line card 14. Data carried by client optical signals supplied to the line card 14 may be processed and encoded and output as line side optical signals. Further, data carried by a received line side optical signal may be processed and decoded and output as client-side optical signals.

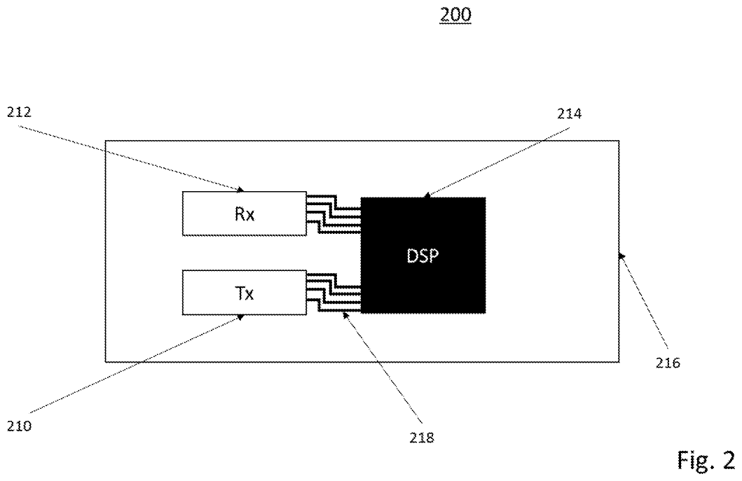

FIG. 2 shows a simplified plan view of a transceiver package 200 consistent with an aspect of the present disclosure, which may be provided on a line card 14 shown in FIG. 1. The package 200 includes a Tx module 210, which may be, for example, a coherent optical transmitter module, a Rx module 212, which may be, for example, a coherent optical receiver module, and a digital signal processor (DSP) 214. The Tx module 210, Rx module 212, and DSP 214 are mounted on a monolithic substrate 216, such as a low temperature co-fired ceramic (LTCC) substrate.

The DSP 214 is connected to the Tx module 210 and the Rx module 212 by high speed electrical interconnects 218. The electrical interconnects 218 may include, for example, controlled impedance transmission lines, which match or substantially match the impedances of the input of the Tx module 210 and the output of the DSP 214 and match or substantially match the impedances of the output of the Rx module 212 and the input of the DSP 214. The substrate 216 may include multiple layers or may include a single layer. The substrate 216 may also include ceramic, glass, a polymer, or any combination thereof. Also, the substrate 216 may include a composite of materials (fabricated separately and then later assembled together). Preferably, the properties of the substrate 216, such as the selected dielectric, attenuation of propagating RF signals, thickness, metal layer thickness and cross-sectional area, and the number of metal layers are selected to achieve a desired impedance and impedance mismatch loss.

The package 200 disclosed herein may be designed to minimize reflections and reduce loss in systems having data rates of 88 Gbaud/sec or more, and associated frequencies of at least 40 GHz, and especially at data rates of 100Gbaud/sec and associated frequencies of greater than or equal to 50 GHz. In systems having data rates in the range of 88-132Gbaud/sec, the DSP 214 may be packaged separately, e.g., in a ball grid array (BGA) package. In systems having higher data rates, for example, data rates greater than 100-132 Gbaud/sec, the DSP 214 may be directly attached to the substrate 216, for example, by using flip chip technologies. In such a case, the DSP 214 may be attached to the substrate 216 using, for example, solder paste, solder bumps, Cu bumps, Au bumps, solder balls, solder pre-forms, or any combination of the foregoing, depending upon the pitch and alignment tolerances required by the design. The particular methodology for attaching the DSP 214 to the substrate 216 is preferable selected in order to reduce the additional losses and reflections associated with the DSP 214 packaging.

Preferably the DSP 214 with a BGA package is utilized for data rates up to 88 Gbaud/sec for high-performance (highest QAM rates and reach, e.g., 64-QAM) at 100Gbaud/sec with potentially somewhat degraded performance for high QAM rates (e.g., 32 or 64-QAM). For highest performance at high QAM rates (32 and 64 QAM) at 100Gbd/sec, direct die bumping of the DSP 214 may be preferred. Above 132Gbaud/sec, direct die bumping may be advantageous to achieve high-performance at 64-QAM, or possibly 32-QAM, or even 16-QAM. As used herein, high performance is defined as preferably less than or equal to (<=) 1 dB and at least less than or equal to (<=) 2 dB of the maximum reach for a given baud rate and modulation format without implementation penalties arising from the electrical signal path from the DSP 214 chip(s) to the modulator driver electronics chip or ASIC on the transmitter side as well as the DSP 214 chip(s) to the amplifier electronics chip on the receive side. In the event that there is no driver (amplifier-receiver side ASIC chip coupled to the modulators (detectors), e.g., the modulator driver circuitry is incorporated into the DSP 214 or the modulator is driven directly from the DSP 214 output, the signal path is measured from the DSP 214 chip directly to the modulator (or, on the receiver side, directly to the photodetectors if the amplifier circuitry is incorporated into the DSP 214 or is directly input to the DSP 214 circuitry). The signal path that defines the implementation penalty is inclusive of any packaging of the DSP 214 chip(s) itself and encompasses the elements in the electronic path beyond the DSP 214 chip(s) itself. The maximum reach referenced herein includes the effects of all other parts of the system, including: the transmitter optical signal-to-noise ratio (OSNR), receiver OSNR, launch and received powers over a given fixed channel (where the channel includes fiber loss, dispersion, such as chromatic dispersion and/or polarization mode dispersion, as well as any impacts from amplification employed over the fiber), any non-ideal characteristics of the optical transmitter and receiver PICs, and the characteristics of the DSP 214 (including the number of DAC levels). When a coherent modulation format is employed that utilizes sub-carriers (each of which may have a different modulation format), the definition of maximum reach is for the sub-carrier with the limiting or shortest reach. That is, the maximum reach in that case is the maximum reach of the sub-carrier having the shortest maximum reach, even though other sub-carriers may have a greater maximum reach.

The heterogeneous packaging concepts described herein are advantageous in that they provide for reduced insertion loss and reflections at a given baud rate (over a given frequency range). For coherent modulation, the maximum of this frequency range is typically 0.5-0.6 times the modulation baud rate. The heterogeneous package and related structures consistent with the present disclosure may enable more than (>) a 2 dB and preferably more than (>) a 3 dB reduction in insertion loss improvement at 88-100Gbaud (over a frequency range up to 44-60 GHz) for a packaged (BGA) DSP chip compared to a conventional analog coherent optical (ACO) module connected to DSP through a PC Board (PCB) or via low-loss RF cables that connect a DSP package to an optical transmitter (receiver) package. Cable or wire connections are described, for example, in U.S. patent application Ser. Nos. 15/398,704; 15/398,708; and 15/398,713, each of which having been filed on Jan. 4, 2017, and the entire contents of each of which are incorporated by reference herein. Furthermore, at baud rates of 100-132 Gbaud/sec or higher, DSP chip(s) directly bumped to the low-loss heterogeneous substrate may enable >2 dB or preferably >3 dB reduction in insertion loss improvement at a frequency range up to 50-80 GHz or higher.

If compatible with performance and overall size requirements, then the DSP 214 packaged as ball-grid array (BGA) may be preferable, as it allows the DSP 214 to be pre-screened /tested to be a known good die (KGD) or device before being assembled. A directly bumped DSP die will provide higher performance and smaller overall sizes. In this case, it may be preferable to first attach the DSP 214 to the substrate 216 and then perform performance screening before assembling additional components to the substrate 216 to insure it is a known good package assembly prior to adding additional elements and their associated costs to the package 200. Similarly, it may be advantageous to add additional pre-screening/testing at different stages of the overall assembly of the package 200 to minimize overall costs as well as provide a means of re-working (removing a device that itself or its interconnect to the overall package 200 does not meet performance requirements) before the entire package 200 is completed.

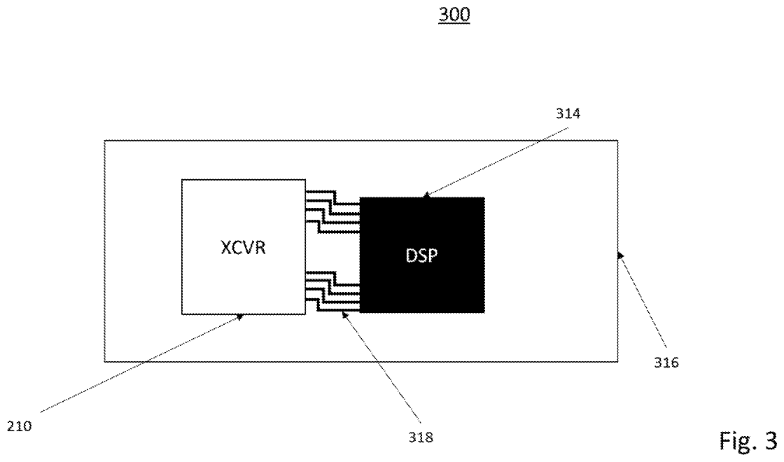

FIG. 3 shows a transceiver package 300, which may also be provided on one or more of the line cards 14 of FIG. 1. As shown in FIG. 3, the package 300 includes a transceiver (XCVR) module 310, which combines the functions of the Tx module 210 and the Rx module 212 of package 200 in FIG. 2, and a DSP 314. The XCVR module 310 and the DSP 314 are mounted on a monolithic substrate 318 and the DSP 314 is connected to the XCVR module 310 by high speed electrical interconnects 318. The electrical interconnects 318 may include, for example, controlled impedance transmission lines, which match or substantially match the impedances of the input of the XCVR module 310 and the output of the DSP 314 and match or substantially match the impedances of the output of the XCVR module 310 and the input of the DSP 314. The other features of the package 300 may be the same as those of the package 200 as described above.

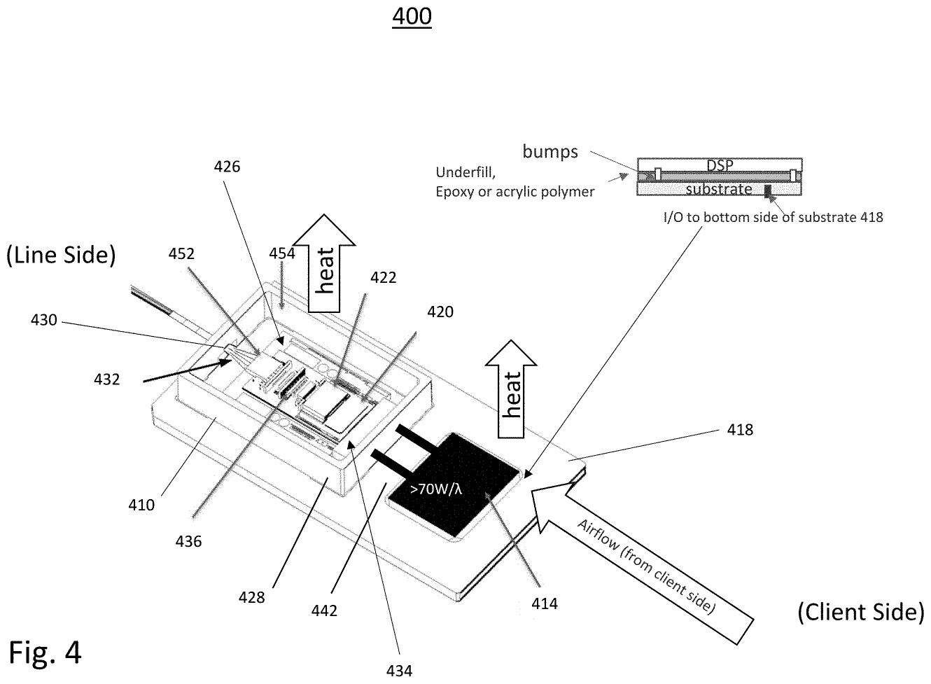

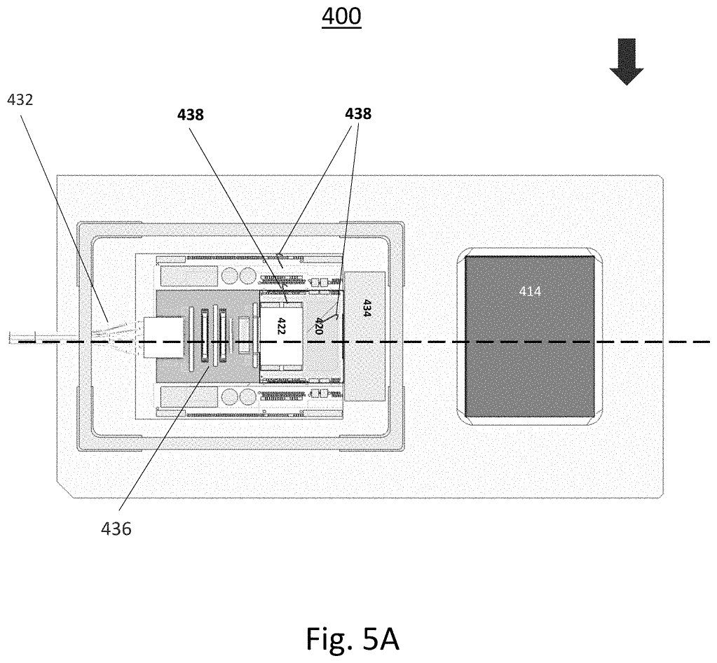

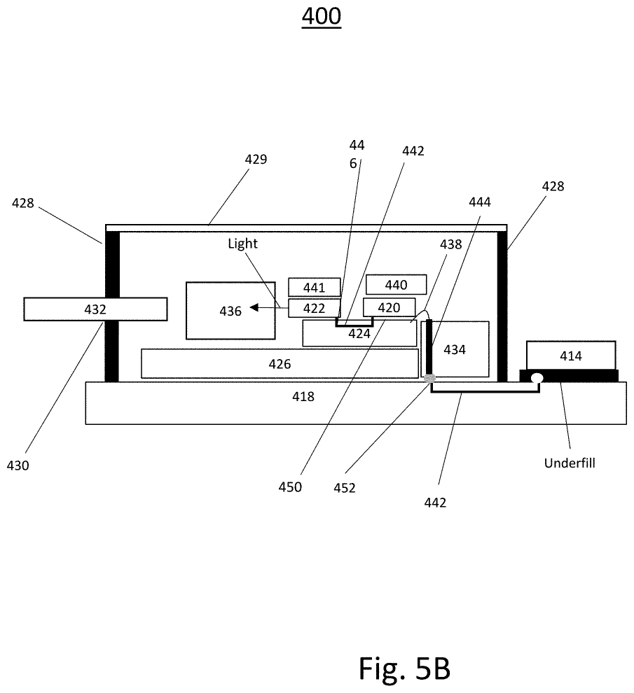

FIGS. 4 and 5A show detailed perspective and plan views, respectively, of a package 400, which is exemplary of the package 300 shown in FIG. 3. FIG. 5B shows a cross sectional view of a portion of the package 400 along the dashed line in FIG. 5A.

As shown in FIGS. 4, 5A and 5B, the package 400 includes a DSP 414 and an XCVR module 410, both mounted on a substrate 418. It should be understood that the XCVR module 410 may be replaced by separate transmitter and receiver modules, such as Tx module 210 and Rx module 212 of FIG. 2.

The XCVR module 410 includes, for example, an ASIC 420, including, for example, a trans-impedance amplifier (TIA) and a Mach-Zehnder modulator driver circuit), an XCRV PIC 422, an interposer 424 (FIG. 5B), an optical platform 426, a barrier 428, such as a ring or wall, with an access or port 430 receiving, for example, one or more optical fibers or fiber array 432, an RF transition element 434, and free space optics (FSO) 436. Wire bonds 438 (FIGS. 5A and 5B) are preferably used to provide electrical connections between the interposer 424 and the RF transition element 434, between the interposer 424 and the optical platform 426, and between the optical platform 426 and the substrate 418. Controlled impedance transmission lines 442 are preferably used to provide electrical connects between the RF transition element 434 and the DSP 414 and between the XCRV PIC 422, the interposer 424, and the ASIC 420. Electrical connections between the wire bonds 438 from the interposer 424 and the controlled impedance transmission lines 442 in the substrate 418 are preferably provided by conductor-filled vias 444 running through the RF transition element 434.

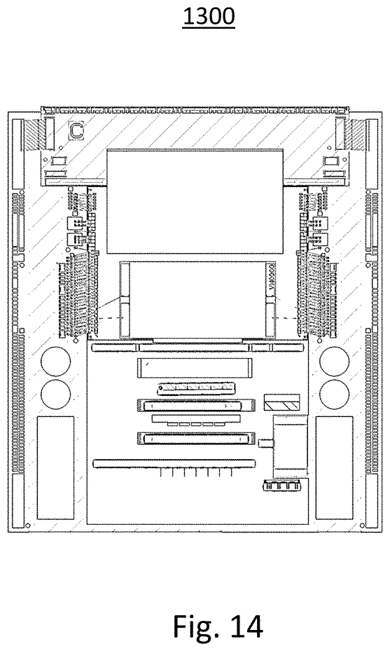

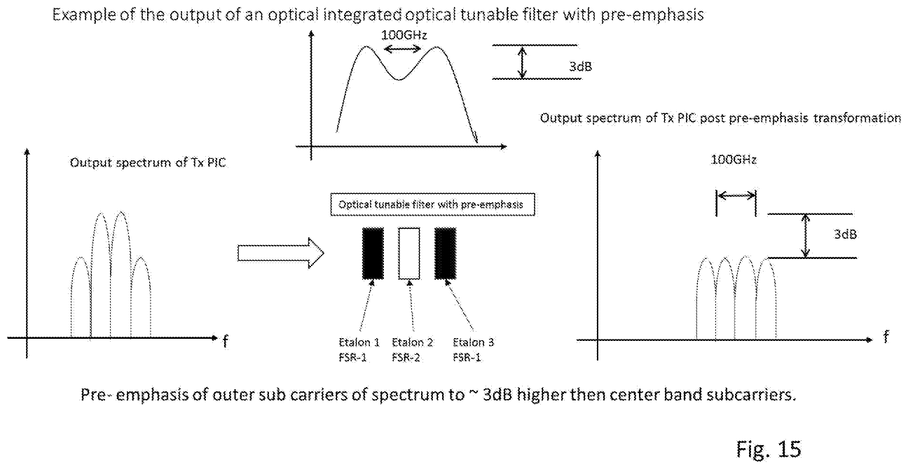

The optical fibers or fiber array 432 may supply optical signals to and receive optical signals form the XCRV PIC 422 via the FSO 436, which may include one or more lenses, polarization combining and splitting (PBC and PBS respectively) elements, and fibers or fiber arrays. The FSO 436 may also include one or more of other discrete optical devices, as described in U.S. patent application Ser. No. 15/814,332, filed Nov. 15, 2017, the entire contents of which are incorporated herein by reference. The FSO 436 is further described below with reference to FIGS. 14 and 15.

The XCVR PIC 422 may be flip chip bonded to the interposer 424 and may transmit and receive optical signals, each having a particular wavelength. The XCVR PIC 420 may be covered by thermo-electric cooler (TEC) 441 for cooling or thermal control. The ASIC 420 may also be flip-chip bonded to the interposer 424. In addition, a heat spreader 440 may be attached to the ASIC 420 for heat spreading and extraction. Additional heat spreaders may be provided for additional thermal control or cooling of the ASIC 420 and/or the XCVR PIC 422.

In a flip chip configuration, the optical output from the XCVR PIC 422 may be in close proximity to the surface of the interposer 424. Typically, a flip-chip joint thicknesses may be 100 microns or less, but may also be 500 microns thick. Also, the optical output of the XCVR PIC 422 is often within 100 microns of the surface of the interposer 424, especially when the joint is 100 microns or less. Since the optical axis of many commercially available FSO elements is spaced more than 100 microns above any mounting structure upon which such elements are attached, the optical elements of the FSO 436 are preferably mounted at a lower height than the XCVR PIC 422, so that the optical input/output of the XCVR PIC 422 may be aligned with the optical axis of the FSO 436. Such alignment of the optical axis can be achieved with the configuration of FIG. 4 by attaching the interposer 424 to the optical platform 426 and selecting the thickness of the interposer 424 such that the optical input/output of the XCVR PIC 422 is aligned with the optical axis of the elements of the FSO 436. Referring to FIG. 5b, as an example, the optical axis A of the mounted elements of the FSO 436 may be 500 microns, the XCRV PIC 422 flip chip joint 446 may be 100 microns thick, the optical axis of the XCVR PIC 422 may be 5 microns higher than the flip chip bumps 448, and the joint thickness between the interposer 424 and optical platform 426 may be 25 microns. Accordingly, in this scenario, providing the interposer 424 with a thickness of 630 microns facilitates alignment of the optical axis of the FSO 436 with the input and output of the XCRV PIC 422.

The optical platform 426 may be made of ceramic, glass, silicon, or polymer. Optionally, the optical platform 426 may be made of the same material as the interposer 424 or of a material having the same or substantially the same (e.g., within 1 ppm/° C.) CTE as the material used for the interposer 424. For example, if the interposer 424 is made of silicon, then the optical platform 426 may be made from a material having a CTE of x where 2.3<x<4.5 ppm//° C.), such materials including silicon, glass, aluminum nitride, silicon carbide. Likewise, if the interposer 424 is made of glass, then the optical platform 426 may be made from a material having a CTE of x where 2.3<x<15 ppm//° C.), and such materials including glass, Kovar®, aluminum oxide, low temperature co-fired ceramic, beryllium oxide, Aluminum silicon carbide, copper tungsten.

As a result, the vertical optical axis of the input/output light of the XCVR PIC 422 may be maintained or substantially maintained over a relatively wide range of temperatures. Those skilled in the art will recognize that other structures may be employed to accommodate the alignment of the vertical optical axis, including but not limited cavities or steps in the interposer 424, discrete mirrors or MEMS mirrors, or direct mounting of the interposer 424 to the substrate 418.

If the interposer 424 and FSO 436 are attached directly to the substrate 418, the thickness of the interposer 424 and joint between the interposer 424 and the substrate 418 may be used to match or align the optical axis of the XCVR PIC 422 and the optical axis of the elements of the FSO 436. Other designs know to those skilled in the art may be employed for attaching the FSO 426 and/or the interposer 424 to the substrate 418, with or without the optical platform 426.

The RF transition element 434, which may optionally be included in the package 400, may be bonded to the substrate 418. The impedances of the controlled impedance transmission lines 442 and conductor filled vias 444 of the RF transition element 434 preferably match the impedances of the ASIC 420 and the DSP 414. The interposer 424, which may also include controlled impedance transmission lines 442 between the ASIC 420 and the pad of the RF wire bonds 428, may be wire bonded to the RF transition element 434. The RF transition element 434 may be a discrete element or a substrate as shown in FIG. 5a that is soldered to the substrate 418. Alternatively, the RF transition element 434 may be integrated into the substrate 418. The entire electrical path between the RF flip chip bump joints 450 (FIG. 5B) of the ASIC 420 and the joint 452 (FIG. 5B) between the RF transition element 434 and the substrate 418 may provide a controlled impedance connection between the ASIC 420 and the substrate 418.

As shown in FIG. 5A, the wire bonds 438 provide low frequency electrical connections of the XCVR PIC 422 and the joints of the ASIC 420 to periphery wire bond pads on the interposer 434 via interposer routing that terminates at wire bond pads. The wire bonds 438 connect these pads to either the wire bonded to optical platform 426 or the substrate 418. Alternatively, the substrate 418 may incorporate a cavity in which the interposer 424 may be placed and attached. In this case, the RF and low frequency connections to the substrate 418 may be made directly with wire bonds or to other RF transition pieces and/or DC (low frequency) connections. If the interposer 424 includes vias with appropriate impedance, DC (or low frequency, e.g., less than 10 MHz) and RF connections may be made directly to the substrate 418 via solder, eliminating the need to wire bond directly to the substrate 418. As used herein, “solder” includes solder paste, solder bumps, Cu-bumps, solder balls, or solder pre-forms, or any combination of these.

The interposer 424 via may be directly connected to the package substrate with solder for designs that incorporate an optical platform. In that case, the optical platform may also require controlled impedance to complete the electrical connections between the ASIC 420 and the flip chip joints of the XCVR PIC 422 and the substrate 418. Such controlled impedance may be achieved with transmission line traces and/or grounded vias.

As further shown in FIG. 4, the barrier 428 is provided surrounding the XCVR PIC 422 and the ASIC 420. The barrier 428 serves to, among other things, protect the XCVR PIC 422 and the ASIC 420, as well as other components within the barrier 428, from physical damage and to thermally insulate the components within the barrier 428 such that heat generated by the DSP 414 does not negatively affect operation of the components within the barrier 428.

The port or access 430 may be provided in the barrier 428 through which the optical fiber or fiber array 432 extends. The optical fiber or fiber array 432 is connected to a fiber mount 452. Alternatively, the port or access 430 may include a window (not shown) that is transparent to the transmitted and received optical signals, or a lens (not shown) in the barrier 428. As further shown in FIG. 4, inside the barrier 428, adjacent to the port or access 430, the optical fiber or fiber array 432 may be mounted to direct light to/from the FSO 436. The window and fiber or fiber array 432 may supply the transmitted optical signals from the XCVR PIC 422 to the optical network over which the signals are carried and provide optical signals received from the network to the receive portion of the XCVR PIC 422. Alternatively, a fiber connector (not shown) may be mounted on the outside of the barrier 428 into which the fiber or fiber array 432 may be plugged, allowing for the transmission and reception of the optical signals from and to the Tx and Rx portions of the XCVR PIC 422.

As shown in FIG. 5B, an optional lid 429 may be provided to further help protect the components inside the barrier 428 from mechanical stresses and also aid in the insulation of the components. In addition, the barrier 428, together with the lid 429, may hermetically seal the components within the barrier 428/lid 429. The barrier 428 and the lid 429 may be configured such that the lid 429 contacts the heat spreader 440 of the ASIC 420 to facilitate heat extraction away from the ASIC 420 and provide temperature control of the XCVR PIC 422.

Generally, the materials used for the substrate 418, the barrier 428, and the lid 429 should be selected such that differences between the CTEs of the materials and the hardness of the joining materials insure stability and long-term reliability of the substrate 418/barrier 428/lid 429 assembly. For example, the material used for the substrate 418 may have a CTE of 2.3-14 ppm/° C., the material used the barrier 428 may have a CTE of 3.5-14 ppm/° C., and the material used for the lid 429 may have a CTE of 2.3-14 ppm/° C. or 3.5-14 ppm/° C.

For hermetic sealing, the barrier 428 may typically be made from a non-polymer-based material, such as metal, ceramic, glass, or silicon, and may be soldered to the substrate 418. Preferably, the solder joint should be >50 μm-500 μm thick. Materials for a hard solder may include AuSn, SAC, AuGe, and AuSi. Materials for a soft solder may include In, InAg, and InSn.

Also for hermetic sealing, the materials used for the barrier 428 and the substrate 418 should have compatible CTEs. When using a hard solder to bond the barrier 428 to the substrate 418, examples of such materials include: a conventional LTCC (CTE˜11-13 ppm/° C.) for the substrate 418 and stainless steel (CTE˜10-14 ppm/° C.) for the barrier 428; or a low-CTE LTCC (CTE˜4-7 ppm/° C.) for the substrate 418 and a material with a CTE˜3.5-7.5 ppm/° C., such as NiFe alloy, Kovar®, AlSiC, or AlN, for the barrier 428. When using a soft solder to bond the barrier 428 to the substrate 418, examples of such materials include: a high- or low-CTE LTCC (CTE˜4-13 ppm/° C.) for the substrate 418 and the barrier 428. When using glass (CTE˜2.3-14 ppm° C.) as the substrate 418, similar requirements are also placed on the materials used for the barrier 428 and the solder.

For non-hermetic configurations, the barrier 428 may be made of metal, ceramic (e.g., LTCC), glass, silicon, a polymer or epoxy material, or any combination thereof. For non-hermetic configurations, the barrier 428 may be attached to the substrate 418 with a polymer or solder or with a pure mechanical joint.

Preferably, the lid 429 comprises the same material as the barrier 428 and is joined to the barrier 428 by a suitable material, such as solder. Examples of materials used for the lid 429 include, Kovar®, CuW, AISiC, and Cu. Preferably, Kovar with a CTE of ˜5-6 ppm/° C. is used for operating temperatures in the range of −40 to +250° C. If CuW is used, the material preferably has a CTE of ˜6-9 ppm/° C. depending upon the Cu/W composition ratio (the higher the amount of W, the lower the CTE). If AlSiC is used, the material preferably has a CTE of ˜5-8 ppm° C. depending upon the Al/Si/C composition ratio (the higher the amount of Al, the higher the CTE).

However, the material used for the lid 429 may be different than the material used for the barrier 428, in which case the material selections for the lid 429 and the barrier 428 may be the same as those set forth above in regards to the substrate 418 and the barrier 428. For example, when using a hard solder to bond the lid 429 to the barrier 428, examples of such materials include: a conventional LTCC (CTE˜11-13 ppm/° C.) for the lid 429 and stainless steel (CTE˜10-14 ppm/° C.) for the barrier 428; or a low-CTE LTCC (CTE˜4-7 ppm/° C.) for the lid 429 and a material with a CTE˜3.5-7.5 ppm/° C., such as NiFe alloy, Kovar®, AlSiC, or AlN, for the barrier 428. When using a soft solder to bond the lid 429 to the barrier 428, examples of such materials include: a high- or low-CTE LTCC (CTE˜4-13 ppm/° C.) for the lid 429 and the barrier 428. When using glass (CTE˜2.3-14 ppm° C.) as the lid 429, similar requirements are also placed on the materials used for the barrier 428 and the solder.

The DSP 414 may be flip chip bonded to the substrate 418, for example, using Cu pillars, Cu pillars+SAC solder, or Cu pillars+SnAg solder, and connected to the RF transition element 434 via controlled impedance traces in the substrate 418. Traces and wires or only traces may be provided to connect the ASIC 420 to the DSP 414. Such traces and wires, as discussed in greater detail below, may be configured to have a desired impedance to match that of the DSP 414, for example, and minimize other losses such as those caused by absorption and leakage.

As described above in connection with FIG. 1, airflow through the vents 16 may be used to cool the DSP 414 and the devices/components within the barrier 428, such as the FSO 436, the XCVR PIC 422, and the ASIC 420 (collectively referred to as the “optical engine” 454—see FIG. 4). As noted above and shown in FIGS. 4, 5A, and 5B, the ASIC 420 may be bonded face down or flip-chip bonded to the substrate 418 to contact traces in the substrate 418. In one example, the ASIC 418 and the XCVR PIC 422 (as part of the optical engine) may generate 15 W per optical signal or □ and the DSP 414 may generate 70 W per signal or □. Those skilled in the art will recognize that this is only one illustrative example of power per λ per device. Other power configurations are possible.

It is noted that, as further shown in FIG. 5B, electrical connections to the DSP 414 may include short wires that do not have significant RF reflections. The wires may connect to conductors or traces in vias of the RF transition element 434 as noted above. Additional traces on the substrate 418 can carry signals from/to the DSP 414.

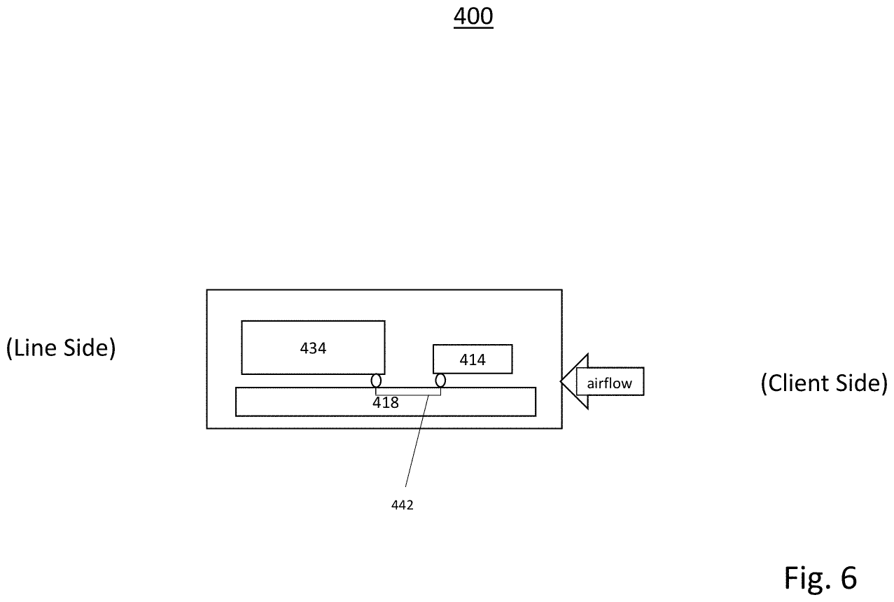

FIG. 6 illustrates simplified cross-sectional view of the package 400 of FIG. 4 showing the controlled impedance transmission lines 422 between the RF transition element 434 and the DSP 414.

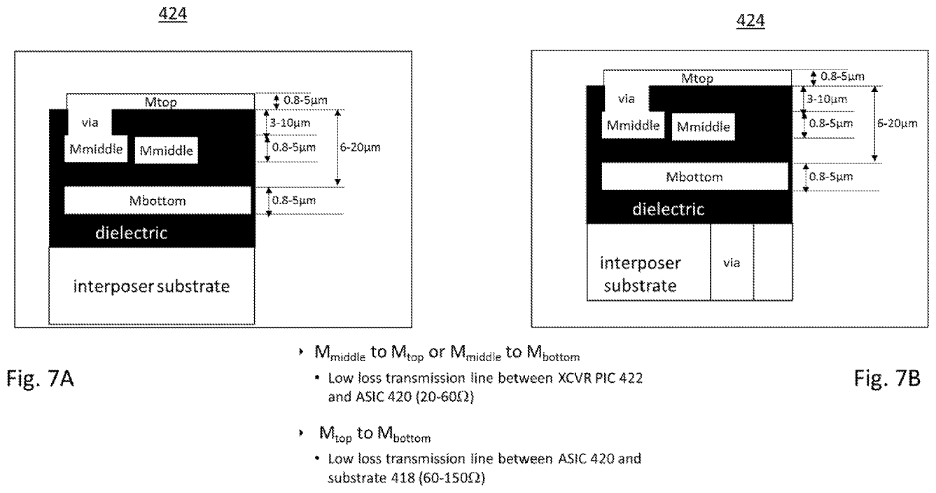

FIGS. 7A and 7B show exemplary configurations of the interposer 424 consistent with the present disclosure. As shown in these figures, the interposer 424 includes metallizations or traces (M) extending horizontally in the figures and connected to each other by conductor-filled vias. The shape and size of the metalizations and conductor-filled vias, as well as the thickness of the dielectric material separating the metalizations and vias, can be selected to provide a desired impedance that matches or substantially matches the impedance of the ASIC 420 and/or the XCVR PIC 422. The conductive paths extending between the DSP 414 and the ASIC 420 and associated dielectrics may be similarly configured to provide an impedance that matches that of the DSP 414. Those skilled in the art will readily recognize that the design of the transmission line for a given impedance and loss may be determined from the combination of metal and dielectric thickness and the number of layers of metal available for the design. Accordingly, the present disclosure is not limited to the specific set of metal and dielectric thicknesses, widths, and lengths disclosed herein. By way of example, the thicknesses and number of layers of metal and dielectric thickness shown in FIGS. 7A and 7B may represent values that provide an impedance in the range of 20 ohms to 150 ohms. For example, M_{middle} to Mₜₒₚ or M_{middle} to M_{bottom} may provide a low loss transmission line between the XCVR PIC 422 and the ASIC 420 with an impendence of 20-60Ω, and Mₜₒₚ to M_{bottom} may provide a low loss transmission line between the ASIC 420 and the substrate 418 with an impendence of 60-150Ω.

In the exemplary configuration of the interposer 424 shown in FIG. 7A, no vias are provided in the interposer substrate. However, in the example shown in FIG. 7B, optional vias in the interposer substrate may provide RF electrical connections between the ASIC 420, the substrate 418, and the DSP 414, as well as low speed or DC connections between the XCVR PIC 422, the ASIC 420, and the substrate 418. By including such vias, a shortened low loss RF path may be provided between the ASIC 420 and DSP 414. Although the foregoing interposer structures have been described in connection with interposer 424 of package 400, the same or similar interposer structures may be used as interposers for any of the packages described herein.

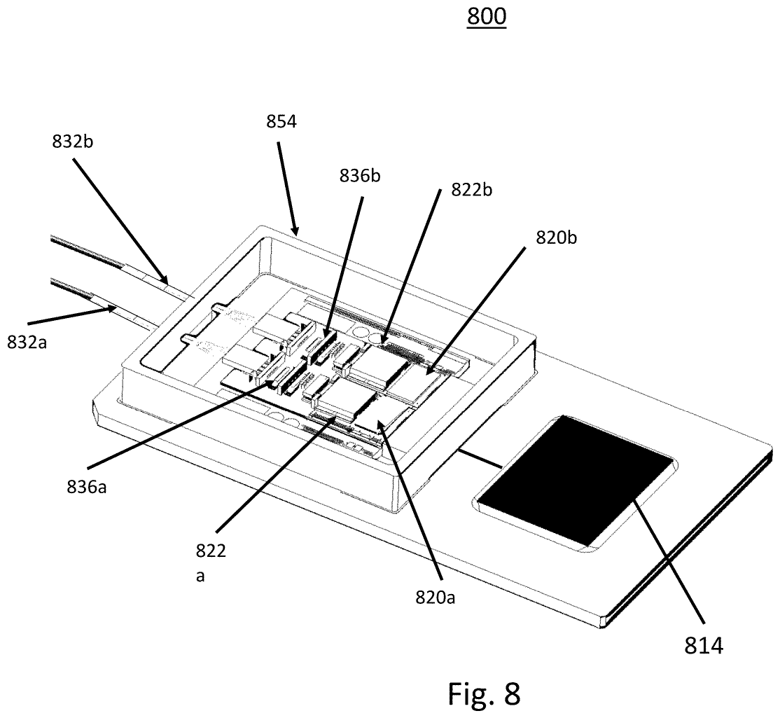

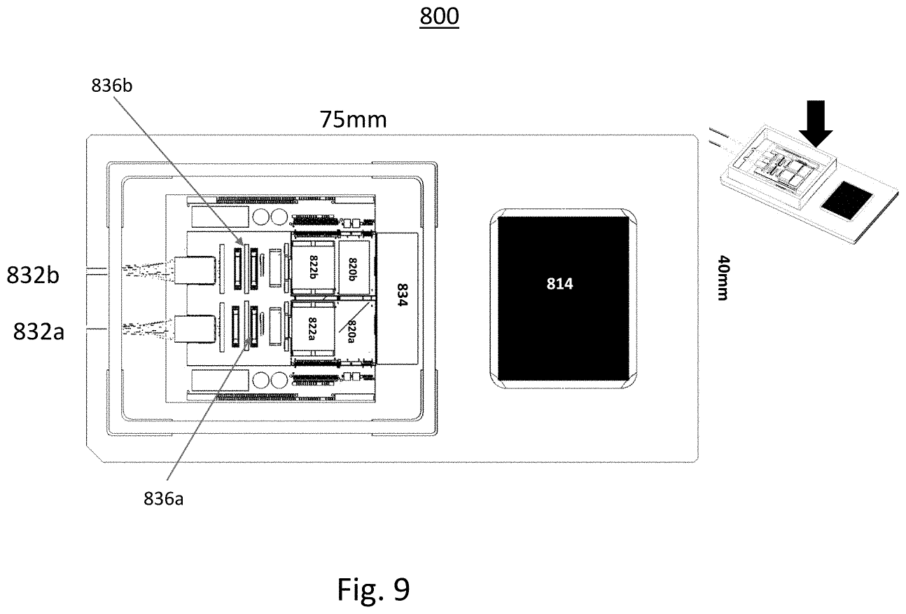

FIG. 8 shows another exemplary package 800, which is similar to the package 400 shown in FIG. 4 except that package 800 includes separate transmit and receive paths within the optical engine 854. As shown in FIG. 8, the package 800 includes a separate Tx PIC 822a and Rx PIC 822b. The Tx PIC 822a supplies first optical signals to Tx fibers 832a via, for example, one or more lenses and associated Tx FSO 836a. The Rx PIC 822b receives optical signals from Rx fibers 832b via, for example, one or more lenses and associated Rx FSO 836b. In addition, a Rx ASIC 820a is provided that includes the TIA, for example, and other circuitry for processing analog electrical signals generated by the Rx PIC 822a. In addition, a TX ASIC 820b is provided including a Mach-Zehnder modulator driver circuit that generates analog electrical signals for driving the Mach-Zehnder modulators in the Tx PIC 822b. The DSP 814 provides electrical signals to the Tx ASIC 820b and the Rx ASIC 820a in a manner similar to that described above in regards to package 400. The other features of package 800 are similar to those described above in regards to package 400.

FIG. 9 shows a plan or top view of the package 800 shown in FIG. 8 with exemplary dimensions. Like the package 400, the package 800 also includes an RF transition element 834, which is similar to RF transition element 434 of package 400.

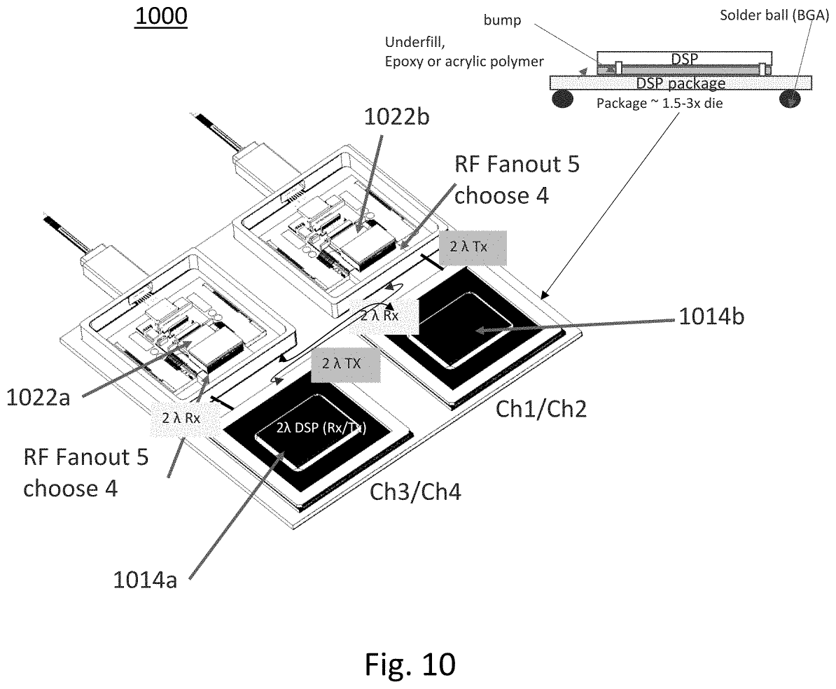

FIG. 10 shows another exemplary package 1000, which is similar to the package 800 shown in FIG. 8 except that Tx PIC 1022b and Rx PIC 1022a are provided in separate modules. The optical connections are otherwise similar to that discussed above in connection with package 800 of FIG. 8. Further, in the example shown in FIG. 10, two separate DSPs 1014a and 1014b are provided, each of which includes circuitry for processing electrical signals to be supplied to a Tx ASIC (not shown) as well as circuitry for processing electrical signals received from an Rx ASIC (not shown). Tx circuitry in the “Ch1/Ch2” DSP 1014b and the “Ch3/Ch4” DSP 1014a provide electrical signals to the Tx ASIC, which provides drive signals for modulating two optical signals, each at a different wavelength. Such modulated optical signals are output on a first fiber. In addition, electrical signals output from the Rx ASIC are supplied to receiver circuitry in the “Ch1/Ch2” DSP 1014b and receiver circuitry in the “Ch3/Ch4” DSP 1014a. Accordingly, in the example shown in FIG. 10, two modulated optical signals may be transmitted and two modulated optical signals may be received, such that the package 1000 shown in FIG. 10 has increased capacity compared to the packages discussed above.

In the example shown in FIG. 10, each DSP has circuitry for processing data to be transmitted on a channel, as well as data received on another channel, such that data associated with four channels are processed. Consistent with the present disclosure, however, DSPs may be provided that process more than four channels.

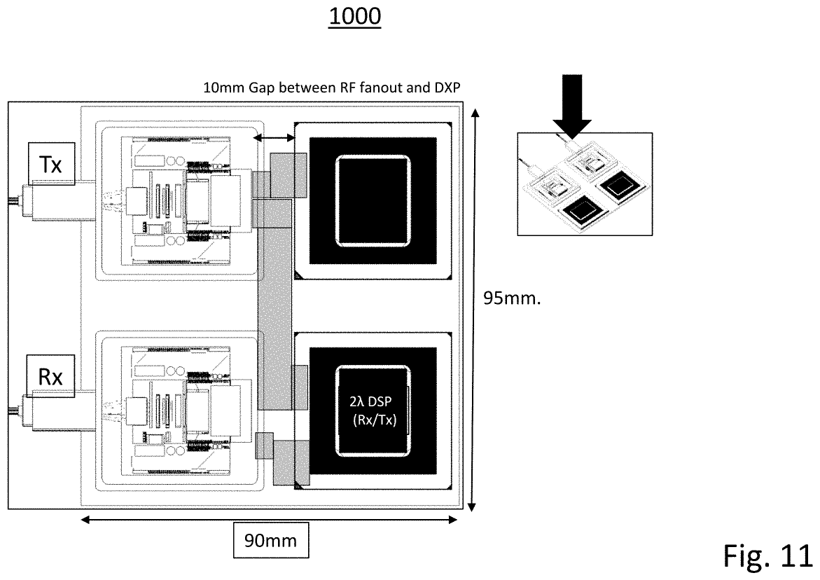

FIG. 11 shows a plan view of the package 1000 shown in FIG. 10 with exemplary dimensions.

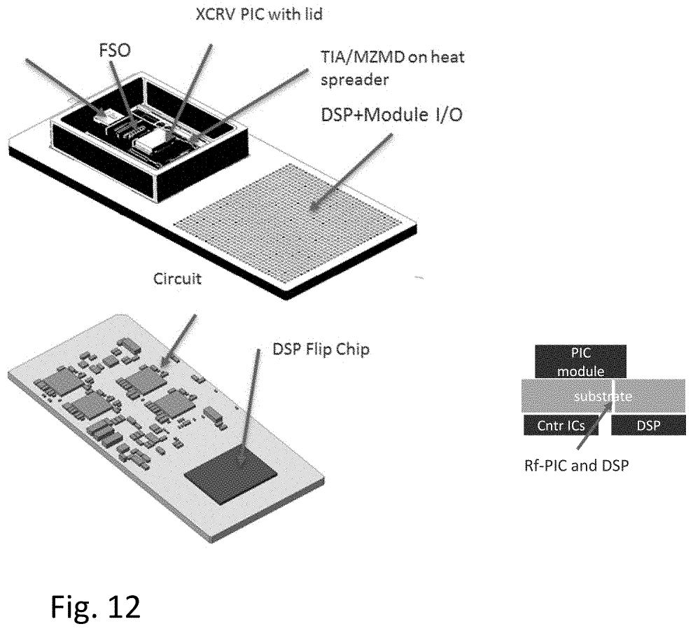

FIG. 12 illustrates another example of a package 1200 consistent with the present disclosure, in which the DSP is flip-chip bonded to one side of a substrate along with associated control circuits (which may or may not be flip chip bonded to the substrate), and a XCVR PIC and ASIC are provided on the opposite side of the substrate. Conductor-filled vias extending from the DSP through the substrate connect to input/output (I/O) conductors on the PIC side of the substrate. Traces extend from the I/O conductors to the ASIC to complete the connections. As further shown in FIG. 12, drivers, power supplies, and control circuitry may be provided on the side of the substrate where DSP is located.

An advantage of the package shown in FIG. 12 is that the PIC and ASIC are more thermally isolated from the DSP than in the examples discussed above. Accordingly, air flowing from the vents shown in FIG. 1 and over the DSP (which generates more heat than the PIC and ASIC) does not substantially heat the PIC and ASIC.

Although FIG. 12 shows the DSP and associated control circuitry on one side of the substrate and the PIC/ASIC on the other side, other configurations are contemplated herein. For example, one or more of the control electronics, power supplies, and low-frequency/DC drivers for the PICs, ASICs, and DSP may be provided on one side of the substrate, and the remaining circuits, chips and devices may be provided on the other side. Alternatively, one or more of the foregoing may be provided on a separate (daughter) card that is connected to the substrate by a connector, such as one or more flex connectors. For example, additional electronics, such as control electronics, beyond the DSP may be provided on either side of the substrate, independent of where DSP is. Preferably, electronics, such as control electronics, associated with PIC and/or ASIC should be on same side of the substrate as the PIC and/or ASIC. Similarly, electronics associated with the DSP are preferably provided on the same side of the substrate as the DSP. However, the PIC, ASIC, and DSP may be provided on the same substrate, as noted above, and the electronics, such as the control electronics, may also be provided on the same side as these devices.

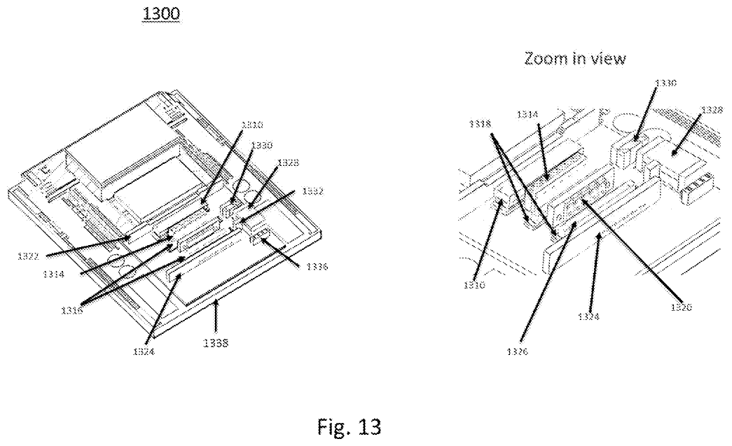

FIG. 13 is a plan view and FIG. 14 is a perspective view of an exemplary FSO 1300 consistent with the present disclosure. The FSO 1300 may be used as the FSO for any of the packages described herein. As shown in FIGS. 13 and 14, the FSO 1300 includes: an optical isolator 1310; a polarization beam splitting/combining element 1314; monitor photodiode (PD) arrays 1316 (with optional integrated beam splitters) affixed to bond pads 1318; a variable optical attenuator (VOA) 1320; a PIC lens (for single channel applications) or lens array (for multiple channel applications) 1322 for focusing light onto a PIC; a fiber lens (for single channel applications) or lens array (for multiple channel applications) 1324; a beam splitter 1326; a dual air etalon 1328 operating, for example, at 50 GHz FSR and having, for example, a 0.6 mm pitch and 3 mm long air gap; a beam splitter/mirror 1330; a slope filter 1332; and a PD array 1336.

The foregoing components are secured to a carrier 1338. If the FSO 1300 is to be hermetically sealed, then the carrier 1338 can be made of, for example a ceramic, LTCC, glass or silicon. If the FSO 1300 is not to be hermetically sealed, then the carrier 1388 can be made of, for example, a polymer. The PD array 1336 may have a 0.6 mm pitch for dual etalon applications and may include, for example, two photodiodes for dual etalon applications and a single diode for the slope filter 1332, and may have a 0.6 mm pitch. The VOA 1320 may, for example, be attached by conductive epoxy to connection pads having, for example, a 0.4 mm pitch. Some or all of the components described above may be provided externally to the optical engine, for example outside of the barrier of the package. In addition some or all of the FSO functionality may be integrated on and carried out by the PIC.

FIG. 15 shows an example of a tunable optical filter with pre-emphasis that may be included in the FSO 1300 of FIGS. 13 and 14. The tunable optical filter may include first and second etalons and a third etalon provided between the first and second etalons. The first and second etalons may have the same free spectral range (FSR), FSR-1, while the third etalon has an FSR, FSR-2, that is different than FSR-1. Collectively, the three etalons have the transmission characteristic shown in FIG. 15. The modulator of the Tx-PIC may output a plurality of optical sub-carriers. Under certain circumstances, the edge sub-carriers may have less power than the center sub-carriers. Equalizing the power of each of the sub-carriers is desirable, however, to reduce errors in the detected data.

Accordingly, consistent with the present disclosure, the pre-emphasis filter shown in FIG. 15 has a transmission characteristic with greater attenuation at frequencies corresponding to the center sub-carriers than the edge sub-carriers. As a result, the center sub-carriers are attenuated more than the edge sub-carriers, such that power of each sub-carrier is uniform. The amount of attenuation and frequencies at which such attenuation is selectively applied may be tuned by, for example, mechanically or thermally controlling the etalons of the filter.

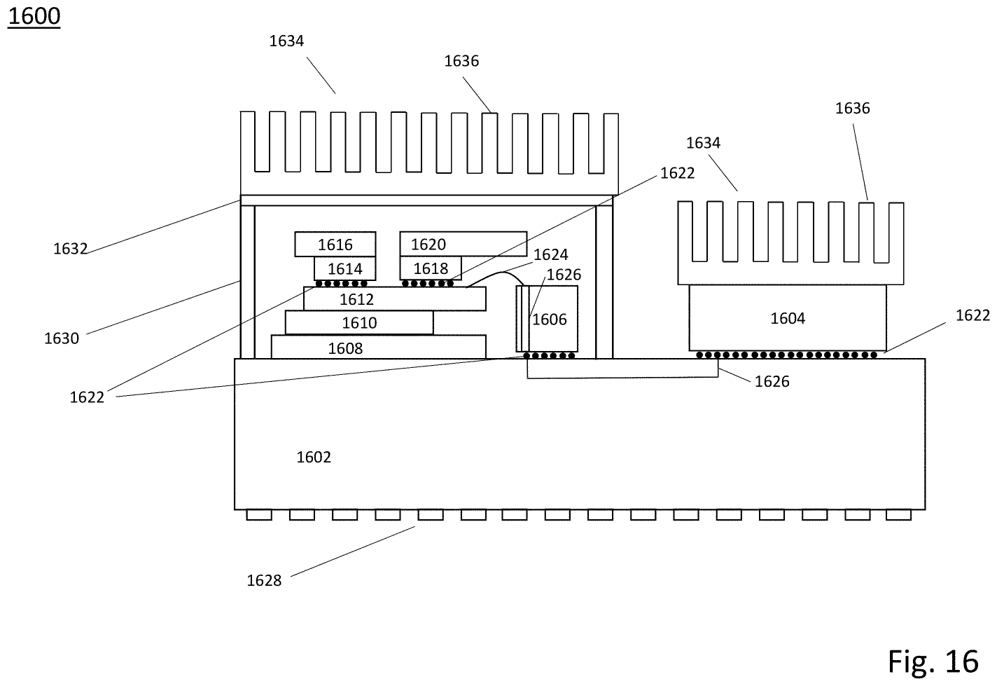

FIG. 16 shows another example of a package 1600 consistent with the present disclosure. As shown in FIG. 16, package 1600 includes: a substrate 1602 comprising, for example, a multi-layer LTCC substrate; a DSP 1604 comprising, for example, either a DSP in die form or a packaged DSP; an RF transition element 1606 comprising, for example, LTCC RF transition element; a carrier 1608 including electrical interconnects for wire bonds or solder joints and made, for example, of materials such as a ceramic, LTCC, glass, or a polymer; an optical platform 1610; an interposer 1612; a 1614, for example, a Tx PIC, a Rx PIC, and/or a XCVR PIC; a TEC 1616; an ASIC 1618; a heat sink 1620. The DSP 1604 and the RF transition element 1606 may be soldered 1622 to the substrate 1602 and the PIC 1614 and the ASIC 1618 may be soldered 1622 to the interposer 1623, for example, by means of BGA or direct die bumping techniques. The PIC 1614 and ASIC 1618 may be electrically coupled to the DSP 1604 by a combination of wire bonding 1624, the soldering 1622, and vias 1626 as shown. Connections 1628 to and mounting of the package 1600 may be provided, for example, by means of land grid array (LGA), pin grid array (PGA), or BGA packaging. Other connections between the various elements of the package 1600, including between the PIC 1614 and the ASIC 1618, as well as between the ASIC 1618 and the DSP 1604, are not shown in detail for ease of illustration. It is understood, however, that such connections may be the same or similar to those described above in connection with FIGS. 1-15.

As further shown in FIG. 16, the package 1600 further includes a barrier 1630 and lid 1632, as well as heat sinks 1634 thermally coupled to the lid 1632 and the DSP 1604 as shown to extract or dissipate head generated by the PIC 1614, the ASIC 1618, and the DSP 1604. Each heat sink 1634 may include a plurality of fins 1636 and/or heat pipes or other known devices or structures suitable for heat extraction or dissipation.

Although not shown in FIG. 16, FSO elements, optical fibers/arrays and connections, and additional integrated circuits (ICs) and circuit elements, for example, for control of the PIC 1614 and the ASIC 1618, as described in connection with the packages shown in FIGS. 1-15 may also be integrated into the package 1600, including into the optical module defined by the barrier 1630 and the lid 1632. Some or all of such FSO elements, optical fibers/arrays and connections, and additional integrated circuits (ICs) and circuit elements may be discrete devices or integrated onto the PIC 1614, the ASIC 1618, or both.

Additional ICs and passive electronics may also be required for operation of the packages described herein. Such ICs and passive electronics can be connected to a separate PCB, which may be connected to the substrate of the package. Connections to the PCB may be made, for example, with solder, pin grid arrays, ball grid arrays, cable, and/or any other suitable electrical connection. In addition, client-side optical devices may be connected to the PCB using one or more of these connection technologies.

It may further be desirable to prevent any solder that connects the devices or elements on the top of the package, such as the optical engine, fanout, and the DSP, from being exposed to reflow temperatures during manufacture/assembly of the package. It may also be desirable to prevent any polymers used in the package, especially in the FSO assembly, from being exposed to temperatures at or above the glass transition temperature of those polymers. Thus, it is preferable to employ a solder connection between the package assembly and any underlying PCB that can be formed at temperatures <˜130-150° C. Unfortunately, most solders that melt at such temperatures (e.g., solders made from InSn, InAg, InAgSn, or BiSn) typically have low current carrying capabilities and are may be weak and/or brittle. These electrical and physical properties tend to rule out the use of such materials for electrical connections for the package. Thus, consistent with the present disclosure, a low temperature solder paste on the PCB pads may be used and a higher temperature (>˜200° C. melting point) solder, such as SnAgCu, SnAg, SnCu, or high temperature Pb, may be used for the solder ball to the package. The low temperature solder paste will melt at temperatures where no damage to the heterogeneous structure or performance of the package will be encountered and will also react with the higher melting point solder ball. This reaction will form a metallurgical bond as well as create an alloy that has adequate current carrying capabilities and mechanical properties to insure long-term reliable high performance connections between the PCB and the package.

Other embodiments will be apparent to those skilled in the art from consideration of the specification. For example, although an ASIC is disclosed above as providing/receiving electrical signals to/from the PIC, consistent with a further aspect of the present disclosure, the ASIC may be omitted and electrical signals may be provided to/received from the DSP with one or more of the electrical connections described above. In addition, although in the above-described examples both the Tx and Rx ASICs are included within a hermetic package defined by the barrier (i.e., in the optical sub-assembly), it is understood that these ASICs may be provided on the package substrate but outside the barrier. It is intended that the specification and examples be considered as exemplary only, with a true scope and spirit of the invention being indicated by the following claims.

What is claimed is:

1. An optical transceiver package comprising:
a transceiver module;
a digital signal processor (DSP);
a substrate supporting the transceiver module and the DSP; and
a barrier to mechanically protect and thermally insulate the transceiver module,
wherein the substrate comprises a material having a coefficient of thermal expansion (CTE) of 2.3-14 ppm/° C. and the barrier comprises a material having a CTE of 3.5-14 ppm/° C.

2. The optical transceiver package of claim 1, wherein the transceiver module includes a transceiver photonic integrated circuit (PIC) and an application specific integrated circuit (ASIC) that generates analog drive signals for the transceiver PIC.

3. The optical transceiver package of claim 1, further comprising a lid, wherein:
the barrier and the lid hermitically seal the transceiver module;
the substrate comprises a low temperature co-fired ceramic having a CTE of 11-13 ppm/° C.;
the barrier comprises stainless steel; and
the barrier is soldered to the substrate using a hard solder.

4. The optical transceiver package of claim 1, further comprising a lid, wherein:
the barrier and the lid hermitically seal the transceiver module;
the substrate comprises a low temperature co-fired ceramic having a CTE of 4-7 ppm/° C.;
the barrier comprises a material having a CTE of 3.5-7.5 ppm/° C.; and
the barrier is soldered to the substrate using a hard solder.

5. The optical transceiver package of claim 1, further comprising a lid, wherein:
the barrier and the lid hermitically seal the transceiver module;
the substrate comprises a low temperature co-fired ceramic having a CTE of 4-13 ppm/° C.;
the barrier comprises a material having a CTE of 4-13 ppm/° C.; and
the barrier is soldered to the substrate using a soft solder.

6. The optical transceiver package of claim 1, further comprising a lid, wherein:
the barrier and the lid hermitically seal the optical transceiver;
the substrate comprises a glass having a CTE of 2.3-14 ppm/° C.;
the barrier comprises a material having a CTE of 4-13 ppm/° C.; and
the barrier is soldered to the substrate using a soft solder.

7. The optical transceiver package of claim 1, wherein:
the barrier comprises at least one of a metal, a ceramic, a glass, silicon, a polymer, an epoxy, or a combination thereof; and
the barrier is attached to the substrate using a polymer, a solder, or a mechanical joint.

8. An optical transceiver package comprising:
a transmitter photonic integrated circuit (PIC);
a receiver PIC;
a digital signal processor (DSP);
a substrate supporting the transceiver module and the DSP; and
a barrier to mechanically protect and thermally insulate the transmitter PIC and the receiver PIC
wherein the substrate comprises a material having a coefficient of thermal expansion (CTE) of 2.3-14 ppm/° C. and the barrier comprises a material having a CTE of 3.5-14 ppm/° C.

9. The optical transceiver package of claim 8, further comprising a lid, wherein:
the barrier and the lid are configured to hermitically seal the transmitter PIC and the receiver PIC;
the substrate comprises a low temperature co-fired ceramic having a CTE of 11-13ppm/° C.;
the barrier comprises stainless steel; and
the barrier is soldered to the substrate using a hard solder.

10. The optical transceiver package of claim 8, further comprising a lid, wherein:
the barrier and the lid hermitically seal the transmitter PIC and the receiver PIC;
the substrate comprises a low temperature co-fired ceramic having a CTE of 4-7 ppm/° C.;
the barrier comprises a material having a CTE of 3.5-7.5 ppm/° C.; and
the barrier is soldered to the substrate using a hard solder.

11. The optical transceiver package of claim 8, further comprising a lid, wherein:
the barrier and the lid hermitically seal the transmitter PIC and the receiver PIC;
the substrate comprises a low temperature co-fired ceramic having a CTE of 4-13ppm/° C.;
the barrier comprises a material having a CTE of 4-13 ppm/° C.; and
the barrier is soldered to the substrate using a soft solder.

12. The optical transceiver package of claim 8, further comprising a lid, wherein:
the barrier and the lid hermitically seal the transmitter PIC and the receiver PIC;
the substrate comprises a glass having a CTE of 2.3-14 ppm/° C.;
the barrier comprises a material having a CTE of 4-13 ppm/° C.; and
the barrier is soldered to the substrate using a soft solder.

13. The optical transceiver package of claim 8, wherein:
the barrier comprises at least one of a metal, a ceramic, a glass, silicon, a polymer, an epoxy, or a combination thereof; and
the barrier is attached to the substrate using a polymer, a solder, or a mechanical joint.

14. An optical transceiver package comprising:
a transmitter module including a transmitter photonic integrated circuit (PIC);
a receiver module including a receiver PIC;
a first digital signal processor (DSP);
a second DSP;
a substrate supporting the transmitter module, the receiver module, the first DSP, and the second DSP;
a first barrier to mechanically protect and thermally insulate the transmitter module; and
a second barrier to mechanically protect and thermally insulate the receiver module
wherein the substrate comprises a material having a coefficient of thermal expansion (CTE) of 2.3-14 ppm/° C., the first barrier comprises a material having a CTE of 3.5-14 ppm/° C., and the second barrier comprises a material having a CTE of 3.5-14 ppm/° C.

15. The optical transceiver package of claim 14, wherein the transmitter module further includes a transmitter application specific integrated circuit (ASIC) and the receiver module further includes a receiver ASIC.

16. The optical transceiver package of claim 14, further comprising a first lid and a second lid, wherein:
the first barrier and the first lid hermetically seal the transmitter module and the second barrier and the second lid hermetically seal the receiver module;
the substrate comprises a low temperature co-fired ceramic having a CTE of 11-13 ppm/° C.;
the first barrier and the second barrier comprise stainless steel; and
the first barrier and the second barrier are soldered to the substrate using a hard solder.

17. The optical transceiver package of claim 14, further comprising a first lid and a second lid, wherein:
the first barrier and the first lid hermetically seal the transmitter module and the second barrier and the second lid hermetically seal the receiver module;
the substrate comprises a low temperature co-fired ceramic having a CTE of 4-7 ppm/° C.;
the first barrier and the second barrier comprise a material having a CTE of 3.5-7.5 ppm/° C.; and
the first barrier and the second barrier are soldered to the substrate using a hard solder.

18. The optical transceiver package of claim 14, wherein:
the first barrier and the first lid hermetically seal the transmitter module and the second barrier and the second lid hermetically seal the receiver module;
the substrate comprises a low temperature co-fired ceramic having a CTE of 4-13 ppm/° C.;
the first barrier and the second barrier comprise a material having a CTE of 4-13 ppm/° C.; and
the first barrier and the second barrier are soldered to the substrate using a soft solder.

19. The optical transceiver package of claim 14, wherein:
the first barrier and the first lid hermetically seal the transmitter module and the second barrier and the second lid hermetically seal the receiver module;
the substrate comprises a glass having a CTE of 2.3-14 ppm/° C.;
the first barrier and the second barrier comprise a material having a CTE of 4-13 ppm/° C.; and
the first barrier and the second barrier are soldered to the substrate using a soft solder.

20. The optical transceiver package of claim 14, wherein:
the first barrier and the second barrier comprise at least one of a metal, a ceramic, a glass, silicon, a polymer, an epoxy, or a combination thereof; and
the first barrier and the second barrier are attached to the substrate using a polymer, a solder, or a mechanical joint.
